(19) United States
(12) Patent Application Publication
(10) Pub. No.: US 2019/0218393 A1
(43) Pub. Date: Jul. 18, 2019

(54) POLYMER COMPOSITION, METHOD OF MAKING A POLYMER COMPOSITION, AN ARTICLE COMPRISING THE POLYMER COMPOSITION, AND AN ARTICLE-FORMING METHOD

(71) Applicant: SABIC Global Technologies B.V, Bergen op Zoom (NL)

(72) Inventors: Dadasaheb V. PATIL, Evansville, IN (US); Peter JOHNSON, Evansville, IN (US); Wei ZHAO, Mt. Vernon, IN (US)

(21) Appl. No.: 16/307,017

(22) PCT Filed: Jun. 19, 2017
(86) PCT No.: PCT/US2017/038135

§ 371 Date: Dec. 4, 2018

Related U.S. Application Data
(60) Provisional application No. 62/352,352, filed on Jun. 20, 2016.

(51) Int. Cl. C08L 79/08; C08L 71/12; C08L 81/04; C08G 73/10

(52) U.S. Cl. CPC C08L 79/08; C08L 71/12; C08L 81/04; C08G 73/1053; C08G 73/1064; C08L 81/06; C08G 73/106; C08L 2203/16; C08L 2203/206; C08L 2203/12; C08L 2203/30; C08G 73/1071

(57) ABSTRACT

A polymer composition includes a poly(biphenyl etherimide) of the formula

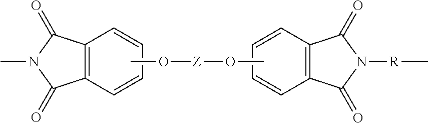

wherein Z and R are as defined herein, and having a glass transition temperature of greater than 230° C. and a second polymer that is not the same as the poly(biphenyl etherimide). A method of making the polymer composition includes melt-mixing the poly(biphenyl etherimide) and the second polymer. Articles comprising the polymer composition and methods of forming the articles are also described.

### BACKGROUND

Polyetherimides are a class of high performance polymers that can be processed to make molded articles, fibers, films, foams, stock shapes, and the like. Polyetherimides further have high strength, toughness, heat resistance, modulus, and broad chemical resistance, and so are widely used in industries as diverse as automotive, telecommunication, aerospace, electrical/electronics, transportation, and healthcare. Polyetherimides have shown versatility in various manufacturing processes, proving amenable to techniques including injection molding, extrusion, and thermoforming, to prepare various articles

Polyetherimides are also known for high heat distortion temperatures and high glass transition temperatures, making their use as coatings, molded articles, composites, and the like very attractive where high temperature resistance is desired. As such, these polymers have found wide use in shaped articles, sheet materials, and coatings for use in challenging physical environments such as aerospace applications, lighting applications, and automotive applications. Due to their high glass transition temperature and high melt viscosity, however, polyetherimides can be difficult to process into finished products.

Accordingly, there remains a need for a high heat polymer composition that exhibits high thermal stability, chemical resistance, and mechanical strength.

### BRIEF DESCRIPTION

A polymer composition comprises a poly(biphenyl etherimide) having a Tg of greater than 230° C., or 240 to 310° C., or 250 to 290° C., and comprising repeating units of formula (1)

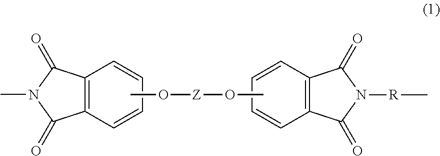

wherein Z is independently at each occurrence derived from a 4,4′-biphenol; and the divalent bonds of the —O—Z—O— group are in the 3,3′, 3,4′, 4,3′, or the 4,4′ positions, preferably the 3,3′ position; and R is independently at each occurrence a C₆₋₂₀ aromatic hydrocarbon group or a halogenated derivative thereof, a straight or branched chain C₂₋₂₀ alkylene group or a halogenated derivative thereof, or a C₃₋₈ cycloalkylene group or a halogenated derivative thereof; and a second polymer that is not the same as the poly(biphenyl etherimide), preferably wherein the second polymer has a Tg of greater than 160° C., or 200 to 300° C., or 220 to 290° C. or has a Tm greater than 260° C., or 260 to 350°, or 300 to 350°.

A method of making the above polymer composition comprises melt-mixing the poly(biphenyl etherimide) and the second polymer.

An article comprising the polymer composition is also described.

A method of forming the article comprises shaping, extruding, blow molding, injection molding, thermoforming, or laminating the polymer composition.

The above described and other features are exemplified by the following detailed description.

### DETAILED DESCRIPTION

The present inventors have unexpectedly discovered a polymer composition prepared from a poly(biphenyl etherimide) can provide a desirable combination of properties, including high thermal stability, high chemical resistance, and high mechanical strength, making the composition particularly suitable for use in high heat applications. Thus, an improvement in high heat polymer compositions is provided by the present disclosure.

Accordingly, a polymer composition represents one aspect of the present disclosure. The polymer composition comprises a poly(biphenyl etherimide). As used herein, the term “poly(biphenyl etherimide” refers to a particular class of poly(etherimide)s comprising repeating units derived from a biphenyl moiety, in particular, a 4,4′-biphenol. The poly(biphenyl etherimide) comprises repeating units of formula (1)

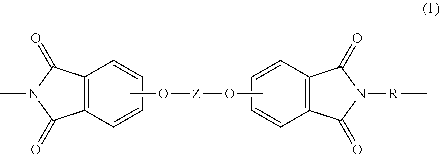

wherein each R is the same or different, and is a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of one or more of the following formulas (2)

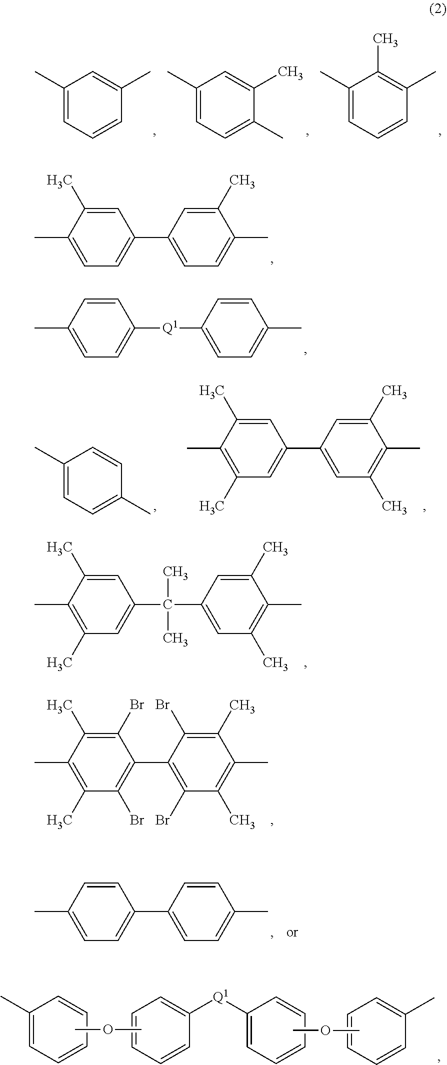

wherein Q¹ is —O—, —S—, —C(O)—, —SO₂—, —SO—, —P(R)(═O)— (wherein R is a C₁₋₆ alkyl or phenyl), —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some embodiments, R is a m-phenylene group, a p-phenylene group, a diarylene sulfone group (e.g., a bis(4,4′-phenylene)sulfone), a diarylene ether group (e.g., a bis(4,4′-phenylene)ether), or a combination comprising at least one of the foregoing. In some embodiments, R is a m-phenylene group.

Further in formula (1), Z is independently at each occurrence a biphenyl group, in particular a group derived from 4,4′-biphenol. The divalent bonds of the —O—Z—O— group can be in the 3,3′, 3,4′, 4,3′, or the 4,4′ positions, preferably the 3,3′ position. In some embodiments, the repeating units having the divalent bonds of the —O—Z—O— group in the 3,3′ position are present in the poly(biphenyl etherimide) in an amount of at least 50 mole percent, preferably at least 90 mole percent, more preferably at least 96 mole percent. Thus, in some embodiments, the poly(biphenyl etherimide) is a 3,3′-poly(biphenyl etherimide) having substantially all the divalent bonds of the —O—Z—O— group in the 3,3′ position.

In an embodiment, Z is a group derived from 4,4′-biphenol, and R is an m-phenylene group, p-phenylene group, diarylene sulfone group (e.g., bis(4,4′-phenylene)sulfone), a diarylene ether group (e.g., bis(4,4′-phenylene)ether), or a combination comprising at least one of the foregoing, preferably a meta-phenylene group.

The poly(biphenyl etherimide) can have a desirable combination of properties.

The poly(biphenyl etherimide) can have at least one of the following properties, or at least two, or at least three, or at least four, or at least five, or at least six of the following properties. In some embodiments, the poly(biphenyl etherimide) can have each of the following properties.

The poly(biphenyl etherimide) has a glass transition temperature (Tg) of greater than 230° C., or 240 to 310° C., or 250 to 290° C. Glass transition temperature can be determined by differential scanning calorimetry according to ASTM D3418.

In some embodiments, the poly(biphenyl etherimide) can have a weight average molecular weight of at least 10,000 grams per mole, preferably 20,000 to 100,000 grams per mole, more preferably 20,000 to 60,000 grams per mole. Weight average molecular weight can be determined by gel permeation chromatography, for example eluting with dichloromethane, and measured relative to polystyrene standards.

In some embodiments, the poly(biphenyl etherimide) includes less than 2 wt % of cyclic oligomers, preferably less than 1.25 wt %, more preferably less than 0.5 wt % cyclic oligomers. In some embodiments, the cyclic oligomer can be of formula (3),

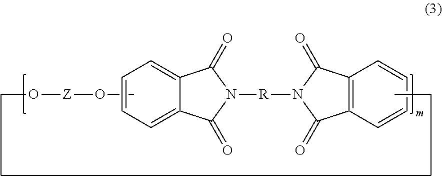

wherein Z and R are as described above. In some embodiments, m in formula (3) can independently be 1 to 10, for example 1 to 5, or 1 to 3, or 1 to 2. In some embodiments, m is preferably 1. In some embodiments, Z is a group derived from 4,4′-biphenol, and R is a m-phenylene group, a p-phenylene group, a diarylene sulfone group, in particular bis(4,4′-phenylene)sulfone, a diarylene ether group, or a combination comprising at least one of the foregoing, preferably a meta-phenylene group.

In some embodiments, the poly(biphenyl etherimide) can have an onset decomposition temperature of greater than 400° C., for example, 400 to 600° C., or 500 to 600° C. The onset decomposition temperature can be determined using thermogravimetric analysis in air or nitrogen, preferably nitrogen.

In some embodiments, the poly(biphenyl etherimide) can exhibit a char yield of greater than 30 wt %, as determined using thermogravimetric analysis under an inert atmosphere of nitrogen.

In some embodiments, the poly(biphenyl etherimide) can have a residual alkali or alkaline earth metal cation content of less than 500 parts per million by weight of the poly(biphenyl etherimide), which can be determined inductively coupled plasma mass spectroscopy (ICP-MS) or ion chromatography (IC). Low alkali or alkaline earth metals can provide improved electrical properties, for example a low comparative tracking index (CTI). Low CTI is especially desirable for electrically insulating compositions.

In some embodiments, the poly(biphenyl etherimide) can have a residual solvent content of less than 1000 ppm, preferably less than 500 parts per million by weight of the poly(biphenyl etherimide), which can be determined by gas chromatography (GC) or liquid chromatography. Polymers having low solvent content are sometimes desired for regulatory and environmental reasons and to achieve polymer part with reduced surface defects such as mold-splay or plate-out.

In some embodiments, the poly(biphenyl etherimide) can be formed by reacting an alkali metal salt of a dihydroxy aromatic compound of the formula (4)

M⁺⁻O—Z—O⁻⁺M (4)

with a bis(halo)phthalimide. M is an alkali metal. Alkali metal M can be any alkali metal, for example lithium, sodium, potassium, and cesium. Thus alkali metal salt is a lithium salt, sodium salt, potassium salt, cesium salt, or a combination comprising at least one of the foregoing. Specific alkali metals are potassium or sodium. In some embodiments, M is potassium. The alkali metal salt can be obtained by reaction of a metal hydroxide with aromatic C₆₋₂₄ monocyclic or polycyclic dihydroxy aromatic compound optionally substituted with 1 to 6 C₁₋₈ alkyl groups, 1 to 8 halogen atoms, or a combination thereof. Z is independently at each occurrence a group derived from biphenol, preferably 4,4′-biphenol. Preferably, the alkali metal salt of the dihydroxy aromatic compound is present in a molar excess of 1.6 to 2.0 mole percent based on the moles of the bis(halo)phthalimide composition.

The bis(halo)phthalimide is of formula (5)

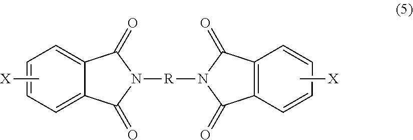

wherein X is independently at each occurrence fluoro, chloro, bromo, iodo or nitro, preferably fluoro, chloro, bromo, or nitro, and R is independently at each occurrence a C6-20 aromatic hydrocarbon group or a halogenated derivative thereof, a straight or branched chain C2-20 alkylene group or a halogenated derivative thereof, a C3-8 cycloalkylene group or halogenated derivative thereof. In some embodiments, the bis(halo)phthalimide can comprise at least 15 wt % of a 3,3-bis(halophthalimide), more than 47 to less than 85 wt % of a 4,3′-bis(halophthalimide), and more than 0 to less than 27 wt % of a 4,4′-bis(halophthalimide).

The bis(halophthalimide) can be prepared by contacting a substituted phthalic anhydride and an organic diamine. The substituted phthalic anhydride can be of the formula (6)

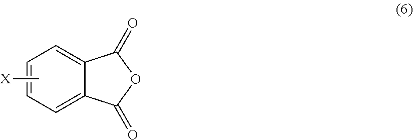

wherein X is a leaving group, as described above, for example a nitro group or a halogen. The organic diamine is of the formula (7)

H₂N—R—NH₂ (7)

wherein R is as defined above. There are no particular limitations on the diamine as long as bis(halophthalimide) can be produced. Exemplary diamines can include those having benzene ring(s), for example diamines having one benzene ring (e.g., p-phenylenediamine, m-phenylenediamine, p-xylylenediamine, and m-xylylenediamine); diamines having two benzene rings (e.g., 3,3′-diaminodiphenylether, 3,4′-diaminodiphenylether, 4,4′-diaminodiphenylether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 2,2-di(3-aminophenyl)-1, 1,1,3,3,3-hexafluoropropane, 2,2-di(4-aminophenyl)-1,1,1,3,3,3-hexafluoropropane, 2-(3-aminophenyl)-2-(4-aminophenyl)-1,1,1,3,3,3-hexafluoropropane, 1,1-di(3-aminophenyl)-1-phenylethane, 1,1-di(4-aminophenyl)-1-phenylethane, and 1-(3-aminophenyl)-1-(4-aminophenyl)-1-phenylethane); diamines having three benzene rings (e.g., 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 1,3-bis(3-amino-α,α-ditrifluoromethylbenzyl)benzene, 1,3-bis(4-amino-α,α-ditrifluoromethylbenzyl)benzene, 1,4-bis(3-amino-α,α-ditrifluoromethylbenzyl)benzene, 1,4-bis(4-amino-α,α-ditrifluoromethylbenzyl)benzene, 2,6-bis(3-aminophenoxy)benzonitrile, and 2,6-bis(3-aminophenoxy)pyridine; diamines having four benzene rings (e.g., 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfide, bis[4-(4-aminophenoxy)phenyl]sulfide, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 2,2-bis[3-(3-aminophenoxy) phenyl]-1,1,1,3,3,3-hexafluoropropane, and 2,2-bis[4-(4-aminophenoxy)phenyl]-1,1,1,3,3,3-hexafluoropropane); diamines having five benzene rings (e.g., 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, and 1,4-bis[4-(4-aminophenoxy)-α,α-dimethylbenzyl]benzene); and diamines having six benzene rings (e.g., 4,4′-bis[4-(4-aminophenoxy)benzoyl]diphenylether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, and 4,4′-bis[4-(4-aminophenoxy)phenoxy]diphenylsulfone). Exemplary diamines can further include diamines having aromatic substituent(s) including, for example, 3,3′-diamino-4,4′-diphenoxybenzophenone, 3,3′-diamino-4,4′-dibiphenoxybenzophenone, 3,3′-diamino-4-phenoxybenzophenone, and 3,3′-diamino-4-biphenoxybenzophenone, or diamines having a spirobiindan ring, for example 6,6′-bis(3-aminophenoxy)-3,3,3′,3′-tetramethyl-1,1′-spirobiindan, and 6,6′-bis(4-aminophenoxy)-3,3,3′,3′-tetramethyl-1,1′-spirobiindan. Ethylene glycol diamines can be used, including bis(aminomethyl)ether, bis(2-aminoethyl)ether, bis(3-aminopropyl)ether, bis[2-(2-aminomethoxy)ethyl]ether, bis[2-(2-aminoethoxy)ethyl]ether, bis[2-(3-aminopropoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, and triethylene glycol bis(3-aminopropyl)ether. Exemplary diamines can further include alicyclic diamines, for example cyclobutanediamine, di(aminomethyl)cyclohexane[bis(aminomethyl)cyclohexanes, including trans-1,4-bis(aminomethyl)cyclohexane and 1,3-bis(aminomethyl)cyclohexane], diaminobicycloheptane, diaminomethylbicycloheptane (including norbornane diamines), diaminooxybicycloheptane, diaminomethyloxybicycloheptane (including oxanorbornanediamine), isophoronediamine, diaminotricyclodecane, diaminomethyltricyclodecane, bis(aminocyclohexyl)methane [or methylenebis(cyclohexylamine)], and bis(aminocyclohexyl)isopropylidene. Exemplary diamines can further include alkylenediamines, such as ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, 1,12-diaminododecane, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, and 2, 2-dimethylpropylenediamine. Siloxane diamines can also be used, for example, 1,3-bis(3-aminopropyl)tetramethyldisiloxane, 1,3-bis(4-aminobutyl)tetramethyldisiloxane, α,ω-bis(3-aminopropyl)polydimethylsiloxane, and α,ω-bis(3-aminobutyl)polydimethylsiloxane. Any regioisomer of the foregoing compounds can be used. Combinations of these compounds can also be used. In some embodiments, R is a meta-phenylene group, a para-phenylene group, a diphenyl sulfone group, a diphenylether group, or a combination comprising at least one of the foregoing, preferably a meta-phenylene group.

The bis(halophthalimide) can be prepared at a temperature of least at 130° C., specifically 150° to 275° C., more specifically 160 to 250° C. Atmospheric or super-atmospheric pressures can be used, for example up to 5 atmospheres, to facilitate the use of high temperatures without causing solvent to be lost by evaporation. The reaction of the substituted phthalic anhydride with the organic diamine to form bis(halophthalimide) can be conducted for 0.5 to 30 hours, specifically 1 to 20 hours, more specifically 1 to 10 hours, still more specifically 2 to 8 hours, and yet more specifically 3 to 7 hours.

The alkali metal salts of the dihydroxy aromatic compounds can be reacted with the bis(halophthalimide) under conditions effective to provide the poly(biphenyl etherimide). For example, the reacting to provide the poly(biphenyl etherimide) can be at a temperature of at least 110° C., specifically 150° to 275° C., more specifically 160 to 250° C. Atmospheric or super-atmospheric pressures can be used, for example up to 5 atmospheres, to facilitate the use of high temperatures without causing solvent to be lost by evaporation. The polymerization can be conducted for 0.5 to 30 hours, specifically 1 to 20 hours, more specifically 1 to 10 hours, still more specifically 2 to 8 hours, and yet more specifically 3 to 7 hours.

In some embodiments, the reacting can be in the presence of a chain stopper (also referred to as an endcapping agent). The chain stopper limits molecular weight growth rate, and thus can be used to controls molecular weight in the poly(biphenyl etherimide). Exemplary chain stoppers can include certain mono amines (for example aniline), mono-phenolic compounds, and the like. In an embodiment, a suitable chain stopper is a monophenol or the corresponding alkali metal salt thereof. For example, the monophenol can be phenol, preferably sodium phenoxide, more preferably sodium para-cumyl phenol. Thus, when a monophenol is included as a chain stopper, the resulting polyetherimide comprises phenyl group as an end cap to the polymer chain. Thus, in some embodiments, the poly(biphenyl etherimide) is end-capped, preferably with a substituted or unsubstituted aromatic primary monoamine. It should be understood however that the polyetherimides disclosed herein can be produced having any desired weight average molecular weight (Mw) with any end cap. In some embodiments, the end capping agent can be present in an amount of 1.5 to 5 mole percent, based on the total moles of the alkali metal salt. The end capping agent can generally be added at any point during the reacting. For example, the end capping agent can be added prior to, during, or at the end of the polymerization. In some embodiments, the end capping agent is added prior to or during the polymerization.

In some embodiments, the reacting can be in the presence of a catalyst. A wide variety of catalysts can be used, for example, various phosphonium, ammonium, guanidinium, and pyridinium salts can be used.

In some embodiments, the catalyst can be a hexa(C₁₋₁₂ alkyl)guanidinium salt, a tetra(C₁₋₁₂ alkyl)ammonium salt, a tetra(C₁₋₁₂ alkyl) phosphonium salt, or a tetra(C₆₋₂₀ aryl) phosphonium salt. For example, the catalyst can be tetraethylammonium bromide, tetraethylammonium acetate, tetrabutylammonium bromide, tetrapropylammonium bromide, tetrabutylammonium chloride, tetrabutylammonium fluoride, tetrabutylammonium acetate, tetrahexylammonium chloride, tetraheptylammonium chloride, Aliquat 336 phase transfer catalyst (methyltrioctylammonium chloride, manufactured by the General Mills Company), tetrabutylphosphonium bromide, tetraphenylphosphonium bromide, tetrabutylphosphonium chloride, hexaethylguanidinium chloride, and the like. A pyridinium salt, for example a bis-aminopyridinium salt can also be used.

In some embodiments, the catalyst can be a quaternary salt or a bis-quaternary salt. Among the quaternary salts that can be used are catalysts of the formula (R³)₄Q⁺X, wherein each R³ is the same or different, and is a C₁₋₁₀ alkyl; Q is a nitrogen or phosphorus atom; and X is a halogen atom or a C₁₋₈ alkoxy or C₆₋₁₈ aryloxy. Exemplary catalysts include (CH₃(CH₂)₃)₄NX, (CH₃(CH₂)₃)₄PX, (CH₃(CH₂)₅)₄NX, (CH₃(CH₂)₆)₄NX, (CH₃(CH₂)₄)₄NX, CH₃(CH₃(CH₂)₃)₃NX, and CH₃(CH₃(CH₂)₂)₃NX, wherein X is Cl⁻, Br⁻, a C₁₋₈ alkoxy or a C₆₋₁₈ aryloxy.

Among the bis-quaternary salts that can be used are those of the formula (R⁴)ₖQ⁺(R³)ₘ⁺Q(R⁴)ₖ (X²)₂ wherein each R³ is independently a divalent C₁₋₆₀ hydrocarbon group, all R³ taken together contain 4-54 carbon atoms, each R⁴ is independently a C₁₋₁₂ hydrocarbon group, Q is nitrogen or phosphorus, preferably nitrogen, X² is an anion-forming atom or group, k is an integer from 1 to 3, and m is 4-k, wherein at least three of R³ and R⁴ groups attached to each Q atom are aliphatic or alicyclic. In particular, each R³ can be a divalent C₁₋₁₈ alkylene, C₃₋₈ cycloalkylene, or C₆₋₁₈ aromatic group such as ethylene, propylene, trimethylene, tetramethylene, hexamethylene, octamethylene, decamethylene, dodecamethylene, cyclohexylene, phenylene, tolylene, or naphthylene, or a C₃₋₁₂ divalent heterocyclic group derived from a compound such as pyridine or indole. In some embodiments, each R³ is C₁₋₁₂ alkylene, specifically C₃₋₈ alkylene. Preferably, only one R³ group is present (i.e., m is 1 and each k is 3) and it contains 5-10, specifically 6 carbon atoms. Illustrative R⁴ groups are methyl, ethyl, n-propyl, isopropyl, n-butyl, isobutyl, n-hexyl, n-heptyl, cyclopentyl, cyclohexyl, methylcyclohexyl, phenyl, tolyl, 2-(1,4-dioxanyl) and 2-furyl. Preferably, the R⁴ groups are all alkyl, for example C₁₋₄ n-alkyl groups. The X² can be any anion that is stable under the conditions used; suitable anions include chloride, bromide, sulfate, p-toluenesulfonate, and methanesulfonate, preferably bromide. The value of the integer k can be from 1 to 3, and the value of m is 4-k. In some embodiments, each k is 3 and m is 1. In the some embodiments, all of the R³ and R⁴ groups are aliphatic. Illustrative bis-quaternary salts of this type include those in which R³ is a polymethylene chain from trimethylene to dodecamethylene, each R⁴ is either n-butyl or n-hexyl, Q is nitrogen, X² is bromide, each k is 2 and m is 2; the compound in which each R³ is ethylene, R⁴ is n-butyl, Q is nitrogen, X² is bromide, each k is 1 and m is 3; and the compound in which R³ is hexamethylene, each R⁴ is n-butyl, Q is phosphorus, X² is bromide, each k is 3 and m is 1.

In some embodiments, the catalyst is preferably a quaternary ammonium salt, guanidinium salt, pyridinium salt, imidazolium salt, or a combination comprising at least one of the foregoing, more preferably wherein the catalyst is a hexaalkylguanidinium salt, even more preferably wherein the catalyst is hexaethylguanidinium chloride.

During the reacting, the catalyst can be present in an amount of 0.1 to 10 mole percent (mol %), preferably 1 to 10 mol %, more preferably 0.5 to 2.0 mol %, based on the total moles of the dialkali metal salt of the dihydroxy aromatic compound. In some embodiments, the polymer composition comprising the polyetherimide prepare according to the above-described method includes less than 1000 parts per million (ppm) by weight of a residual catalyst, based on the weight of the polyetherimide.

In another embodiment, the poly(biphenyl etherimide) can be prepared by reacting an aromatic bis(ether phthalic anhydride) of formula (8)

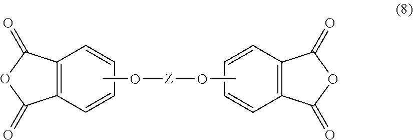

with an aromatic diamine according to formula (7), as described above to provide the poly(biphenyl etherimide), wherein Z in formula (8) is as described above.

The reacting of the aromatic bis(ether phthalic anhydride) with the organic diamine can be under conditions effective to provide the poly(biphenyl etherimide). For example, the reacting can be in the presence of a solvent, for example, N-methylpyrrolidone, dimethylacetamide, dimethylformamide, cresol, veratrole, phenetole, dimethylsulfoxide, trichloromethane, acetone, methanol, ethanol, toluene, benzene, chlorobenzene, bromobenzene, dichlorobenzenes, trichlorobenzenes (e.g., 1,2,4-trichlorobenzene), xylene (including m-xylene, o-xylene, p-xylene, and combinations comprising at least one of the foregoing), anisole, ethylbenzene, propylbenzene, mesitylene, and the like, or a combination comprising at least one of the foregoing. Sufficient solvent is generally utilized to provide a solids content of 1 to 90%, or 10 to 90%, or 10 to 80%, or 15 to 60%.

In some embodiments, the reacting of the aromatic bis(ether phthalic anhydride) with the organic diamine can be in the presence of a chain stopper (also referred to as an endcapping agent). The chain stopper limits molecular weight growth rate, and thus can be used to control molecular weight in the poly(biphenyl etherimide). Exemplary chain stoppers include certain monoamines (for example aniline), monoanhydrides (for example phthalic anhydride), and the like. In an embodiment, a suitable chain stopper is phthalic anhydride. Thus, when phthalic anhydride is included as a chain stopper, the resulting poly(biphenyl etherimide) comprises phthalimide as an end cap to the polymer chain. It should be understood however that the poly(biphenyl etherimide)s disclosed herein can be produced having any desired weight average molecular weight (Mw) with any end cap.

The reacting of the aromatic bis(ether phthalic anhydride) with the organic diamine can be at a temperature of 100 to 250° C., or 120 to 230° C., or 150 to 210° C., or 150 to 250° C., and can be carried out for 0.5 to 10 hours, preferably with agitation (e.g., stirring). To avoid deleterious oxidation reactions, the contacting of the aromatic bis(ether phthalic anhydride) with the organic diamine can be blanketed under an inert gas. Examples of such gases are dry nitrogen, helium, argon and the like. Dry nitrogen can be preferred. The reaction can be run at atmospheric to super-atmospheric pressure.

In addition to the poly(biphenyl etherimide), the polymer composition further comprises a second polymer that is not the same as the poly(biphenyl etherimide). Preferably, the second polymer can have a glass transition temperature of greater than 160° C., or 160 to 300° C., or 180 to 300° C., or 200 to 300° C., or 220 to 290° C. or a melting temperature of greater than 260° C., or 260 to 320° C., or 260 to 300° C.

The second polymer different from the polyetherimide can be, for example, a polyacetal, poly(C₁₋₆ alkyl)acrylate, polyacrylamide, polyamideimide, polyanhydride, polyarylate, polyarylene ether, polyarylene sulfide, polyarylsulfone, polybenzothiazole, polybenzoxazole, polyester, polyetherimide (including copolymers such as polyetherimide-siloxane copolymers), polyimides (including copolymers such as polyimide-siloxane copolymers), polyarylene ether nitrile (PAEN), polyarylene ether ketones (e.g., polyether ether ketones (PEEK) and polyether ketone ketones (PEKK), polyetherketone (PEK)), polyethersulfone, poly(C₁₋₆ alkyl)methacrylate, polymethacrylamide, polynorbornene, polyolefin, polyoxadiazole, polyoxymethylene, polyphthalide, polysilazane, polysiloxane, polystyrene, polysulfide, polysulfonamide, polysulfonate, polysulfone, polythioester, polytriazine, polyurea, polyurethane, polyvinyl alcohol, polyvinyl ester, polyvinyl ether, polyvinyl halide, polyvinyl ketone, polyvinyl thioether, a fluoropolymer (e.g., polyvinylidene fluoride, perfluoroalkoxy, polytetrafluoroethylene), a liquid crystalline polymer, or a combination comprising at least one of the foregoing. In some embodiments, the polymer different from the polyetherimide is polyarylene ether (e.g., polyphenylene ether), polyaryletherketone (e.g., polyetherketone (PEK), polyetheretherketone (PEEK), polyetherketoneketone (PEKK), polyetheretherketoneketone (PEEKK), polyetherketoneetherketoneketone (PEKEKK), and the like), polyimide, polyetherimide, polyphenyl sulfone, polyester, polyarylene sulfide, fluoropolymers, polyamideimide, polyethersulfone, a liquid crystalline polymer, or a combination comprising at least one of the foregoing. In some embodiments, the second polymer is a polyarylene ether, a polyarylene sulfide, a polyarylether ketone, a polyarylether sulfone, a polybenzimidazole, a polyimide, a polyetherimide, a liquid crystalline polymer, or a combination comprising at least one of the foregoing. In other embodiments, the second polymer is a polyaryletherketone or a polyetherimide. The polyetherimide can include copolymers such as poly(siloxane-etherimide) copolymers.

In some embodiments, the second polymer is a polyaryletherketone. The polyarylether ketone comprises repeating units formula (9)

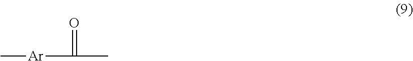

wherein Ar is independently at each occurrence a substituted or unsubstituted, monocyclic or polycyclic aromatic group having 6 to 30 carbons. Exemplary Ar groups include, but are not limited to, phenyl, tolyl, naphthyl, and biphenyl. The polyaryletherketone further comprises repeating units of formula (10)

—Ar—O— (10)

wherein Ar is defined as above. For example, the aromatic polyaryletherketone can comprise repeating units of formula (11)

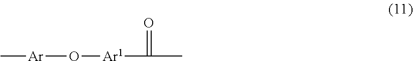

wherein Ar is defined as above and Ar¹ is independently at each occurrence a substituted or unsubstituted, monocyclic or polycyclic aromatic group having 6 to 30 carbons. Ar can be the same as or different from Ar¹. In some embodiments Ar and Ar¹ are phenyl groups.

In some embodiments, the polyaryletherketone can comprise a polyetheretherketone. Polyetheretherketones comprise repeating units of formula (12)

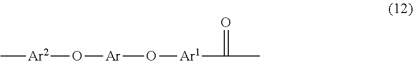

wherein Ar and Ar¹ are defined as above. Ar² is independently at each occurrence a substituted or unsubstituted, monocyclic or polycyclic aromatic group having 6 to 30 carbons. Ar, Ar¹, and Ar² can be the same as or different from each other. Additionally, two of Ar, Ar¹, and Ar² can be the same as each other and the third can be different. In some embodiments Ar, Ar¹, and Ar² are phenyl groups.

Polyaryletherketones are generally known, with many examples being commercially available. Examples of commercially available polyaryletherketones include those sold under the trade name PEEK, available from VICTREX.

In some embodiments, the second polymer is a polyetherimide. Polyetherimides comprise more than 1, for example 2 to 1000, or 5 to 500, or 10 to 100 structural units of formula (13)

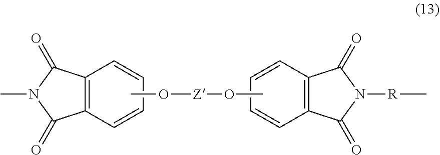

wherein each R is independently the same or different, and can be as described in formula (1). In some embodiments R is m-phenylene, p-phenylene, or a diarylene sulfone, in particular bis(4,4′-phenylene)sulfone, bis(3,4′-phenylene)sulfone, bis(3,3′-phenylene)sulfone, or a combination comprising at least one of the foregoing. In some embodiments, at least 10 mole percent of the R groups contain sulfone groups, and in other embodiments no R groups contain sulfone groups.

Further in formula (13), the divalent bonds of the —O—Z′—O— group are in the 3,3′, 3,4′, 4,3′, or the 4,4′ positions, and Z′ is an aromatic C₆₋₂₄ monocyclic or polycyclic moiety optionally substituted with 1 to 6 C₁₋₈ alkyl groups, 1 to 8 halogen atoms, or a combination comprising at least one of the foregoing, provided that the valence of Z′ is not exceeded. Preferably, Z′ is not the same as Z in formula (1) (i.e., Z′ is not a biphenyl group). Exemplary groups Z′ include groups of formula (14)

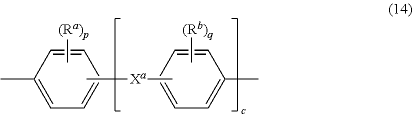

wherein R^{a} and R^{b} are each independently the same or different, and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, P(R) (═O)— (wherein R is a C₁₋₈ alkyl or C₆₋₁₂ aryl), or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z′ is a divalent group of formula (14a)

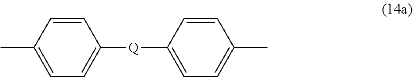

wherein Q is —O—, —S—, —C(O)—, —SO₂—, —SO—, P(R) (═O)— (wherein R is a C₁₋₈ alkyl or C₆₋₁₂ aryl), or —C_{y}H_{2y}— wherein y is an integer from 1 to 5 or a halogenated derivative thereof (including a perfluoroalkylene group). In a specific embodiment Z′ is a derived from bisphenol A, such that Q in formula (15a) is 2,2-isopropylidene.

In an embodiment in formula (13), R is m-phenylene, p-phenylene, or a combination comprising at least one of the foregoing, and Z′ is a divalent group of formula (14a). Alternatively, R is m-phenylene, p-phenylene, or a combination comprising at least one of the foregoing, and Z′ is a divalent group of formula (14a) and Q is 2,2-isopropylidene. Alternatively, the polyetherimide can be a copolymer comprising additional structural polyetherimide units of formula (13) wherein at least 50 mole percent (mol %) of the R groups are bis(3,4′-phenylene)sulfone, bis(3,3′-phenylene)sulfone, or a combination comprising at least one of the foregoing and the remaining R groups are p-phenylene, m-phenylene or a combination comprising at least one of the foregoing; and Z′ is 2,2-(4-phenylene)isopropylidene, i.e., a bisphenol A moiety.

In some embodiments, the polyetherimide is a copolymer that optionally comprises additional structural imide units that are not polyetherimide units, for example imide units of formula (15)

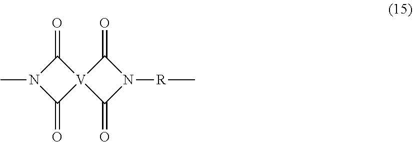

wherein R is as described in formula (1) and each V is the same or different, and is a substituted or unsubstituted C₆₋₂₀ aromatic hydrocarbon group, for example a tetravalent linker of the formulas

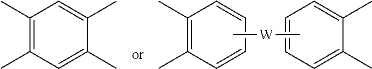

wherein W is a single bond, —S—, —C(O)—, —SO₂—, —SO—, P(R) (═O)— (wherein R is a C₁₋₈ alkyl or C₆₋₁₂ aryl), or —C_{y}H_{2y}— wherein y is an integer from 1 to 5 or a halogenated derivative thereof (which includes perfluoroalkylene groups). These additional structural imide units preferably comprise less than 20 mol % of the total number of units, and more preferably can be present in amounts of 0 to 10 mol % of the total number of units, or 0 to 5 mol % of the total number of units, or 0 to 2 mole % of the total number of units. In some embodiments, no additional imide units are present in the polyetherimide.

The polyetherimide can also comprise a poly(siloxane-etherimide) copolymer comprising polyetherimide units of formula (13) and siloxane blocks of formula (16)

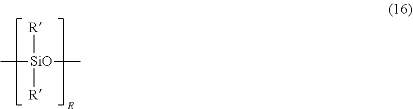

wherein each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination comprising at least one of the foregoing. In an embodiment no bromine or chlorine is present, and in another embodiment no halogens are present. Combinations of the foregoing R′ groups can be used in the same copolymer. In an embodiment, the polysiloxane blocks comprises R′ groups that have minimal hydrocarbon content. In a specific embodiment, an R′ group with a minimal hydrocarbon content is a methyl group.

Examples of specific poly(siloxane-etherimide)s are described in U.S. Pat. Nos. 4,404,350, 4,808,686 and 4,690,997. In an embodiment, the poly(siloxane-etherimide) has units of formula (17)

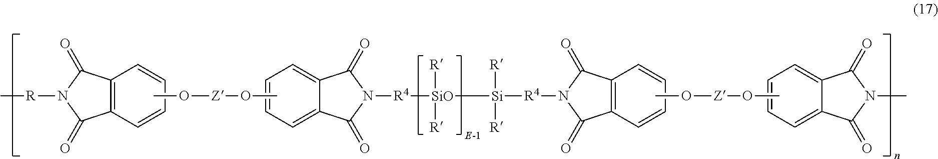

wherein R′ and E of the siloxane are as in formula (16), the R and Z′ of the imide are as in formula (13), R⁴ is independently at each occurrence a C₂-C₂₀ hydrocarbon, in particular a C₂-C₂₀ arylene, alkylene, or arylenealkylene group, specifically a C₂-C₁₀ alkylene group such as propylene, and n is an integer from 5 to 100. In a specific embodiment, the R of the etherimide is a phenylene, Z′ is a residue of bisphenol A, R⁴ is n-propylene, E is 2 to 50, 5, to 30, or 10 to 40, n is 5 to 100, and each R′ of the siloxane is methyl.

The relative amount of polysiloxane units and etherimide units in the poly(siloxane-etherimide) depends on the desired properties, and are selected using the guidelines provided herein. In particular, as mentioned above, the block or graft poly(siloxane-etherimide) copolymer is selected to have a certain average value of E, and is selected and used in amount effective to provide the desired wt % of polysiloxane units in the composition. In an embodiment the poly(siloxane-etherimide) comprises 10 to 50 wt %, 10 to 40 wt %, or 20 to 35 wt % polysiloxane units, based on the total weight of the poly(siloxane-etherimide).

In some embodiments, the second polymer can be a polysulfone. “Polysulfone” as used herein refers to an aromatic polymer comprising one or more —SO₂— linkage, including, for example, polysulfone (PSU), polyethersulfone (PES), polyphenylene sulfone (PPSU), and the like, and combinations comprising at least one of the foregoing. In some embodiments, the polysulfone comprises repeating structural units having the formula

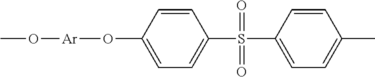

wherein Ar is independently at each occurrence a substituted or unsubstituted divalent organic group, for example a substituted or unsubstituted C₆₋₂₀ aromatic hydrocarbon group. In some embodiments, Ar is a divalent group of the formula

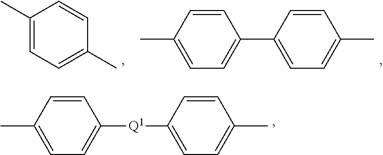

wherein Q¹ is —O—, —S—, —SO₂—, —SO—, —C_{y}H_{2y}— wherein y is an integer from 1 to 5 or a halogenated derivative thereof (which includes perfluoroalkylene groups. In some embodiments, Q¹ is —O—, —SO₂—, or —C_{y}H_{2y}— wherein y is an integer from 1 to 5. In some embodiments, Q¹ is a 2,2-isopropylidene group (e.g., Ar is a group derived from bisphenol A).

Exemplary polysulfones can include those available under the trade name UDEL or RADEL-A, VERADEL, RADEL-R, and ACUDEL, each available from Solvay Specialty Polymers, LLC, and ULTRASON E2010, available from BASF.

In some embodiments, the second polymer can be a liquid crystalline polymer (LCP). Suitable LCPs can be any LCP which, when used in conjunction with the present disclosure, makes it possible to produce a polymer composition within the scope of the present disclosure. Liquid crystal polymers include aromatic polyesters. Illustrative examples of such aromatic polyesters include self-condensed polymers of p-hydroxybenzoic acid, polyesters comprising repeat units derived from terephthalic acid and hydroquinone, polyesters comprising repeat units derived from p-hydroxybenzoic acid and 6-hydroxy-2-naphthoic acid, and the like, or combinations comprising at least one of the foregoing. Specific examples of suitable liquid crystal polymers are available under the tradename ZENITE from Celanese, VECTRA from Ticona, and XYDAR from Solvay.

The polymer composition can include the poly(biphenyl etherimide) in an amount of 1 to 99 wt %, preferably from 10 to 90 wt %, more preferably from 25 to 75 wt %, and the second polymer in an amount of 1 to 99 wt %, preferably from 10 to 90 wt %, more preferably from 25 to 75 wt %, wherein the weight percent is based on the total weight of the poly(biphenyl etherimide) and the second polymer, and totals 100%.

The miscibility of the resulting polymer composition can be adjusted by adjusting the ratio of the poly(biphenyl etherimide) and the second polymer. For example, in some embodiments, the polymer composition can be a miscible composition that exhibits one glass transition temperature, preferably a single glass transition temperature in the range of 150 to 300° C., or does not exhibit a melting point (Tm). In some embodiments, the polymer composition can be an immiscible composition that exhibits more than one glass transition temperature, preferably in the range of 150 to 300° C., or a crystalline melt temperature (Tm).

In an embodiment, the polymer composition is a miscible composition comprising 10 to less than 40 wt %, preferably 20 to 30 wt % of the poly(biphenyl etherimide) and greater than 60 to 90 wt %, preferably 70 to 80 wt % of the second polymer, preferably wherein the second polymer is a polyimide different from the poly(biphenyl etherimide), wherein the wt % is based on the total weight of the poly(biphenyl etherimide) and the second polymer and totals 100%. The resulting miscible composition exhibits one glass transition temperature, preferably a single glass transition temperature in the range of 150 to 300° C. In some embodiments, the miscible composition does not exhibit a melting point (Tm).

In another embodiment, the polymer composition can be a miscible composition comprising greater than 60 to 90 wt %, preferably 70 to 80 wt % of the poly(biphenyl etherimide), and 10 to less than 40 wt %, preferably 20 to 30 wt % of the second polymer, preferably wherein the second polymer is a polyimide different from the poly(biphenyl etherimide), wherein the wt % is based on the total weight of the poly(biphenyl etherimide) and the second polymer, and totals 100%. The resulting miscible composition exhibits one glass transition temperature, preferably a single glass transition temperature in the range of 150 to 300°. In some embodiments, the miscible composition does not exhibit a melting point (Tm).

In yet another embodiment, the polymer composition can be an immiscible polymer composition comprising 40 to 60 wt %, preferably 45 to 55 wt % of the poly(biphenyl etherimide), and 40 to 60 wt %, preferably 45 to 55 wt % of the second polymer, preferably wherein the second polymer is a polyimide different from the poly(biphenyl etherimide), wherein the wt % is based on the total weight of the poly(biphenyl etherimide) and the second polymer, and totals 100%. The resulting immiscible composition exhibits more than one glass transition temperature, characteristic of an immiscible polymer composition. The glass transition temperature can be observed in the range of 150 to 300° C. In some embodiments, the immiscible composition exhibits a crystalline melt temperature (Tm).

In some embodiments, the polymer composition can further include one or more additives. The one or more additives can be selected to achieve a desired property, with the proviso that the additives are also selected so as to not significantly adversely affect a desired property of the polymer composition. The additive composition or individual additives can be mixed at a suitable time during the mixing of the components for forming the polymer composition. The one or more additives can include a filler (e.g., a particulate, fibrillar, or flaked filler, or the like), antioxidant, heat stabilizer, light stabilizer, ultraviolet light stabilizer, UV absorbing additive, plasticizer, lubricant, release agent, antistatic agent, anti-fog agent, antimicrobial agent, colorant, surface effect additive, radiation stabilizer, flame retardant, anti-drip agent, or a combination comprising at least one of the foregoing. The additives are used in the amounts generally known to be effective. For example, the total amount of the additives (other than any impact modifier, filler, or reinforcing agent) can be 0.001 to 10.0 wt %, or 0.01 to 5 wt %, each based on the total weight of the polymer components in the thermoplastic composition. In an embodiment, the polymer composition further comprises a residual catalyst, impact modifier, filler, reinforcing agent, anti-oxidant, thermal stabilizer, light stabilizer, ultraviolet light absorber, quencher, plasticizer, lubricant, mold release agents anti-static agent, colorant, blowing agent, flame retardant, anti-drip agent, radiation stabilizer, or a combination comprising at least one of the foregoing. In an embodiment, the polymer composition further comprises one or more additives selected from the group consisting of particulate filler, reinforcing agent, lubricants, colorants, stabilizers, mold release agents, UV absorbers, or a combination thereof. In some embodiments, the polymer composition is devoid of any additives, or the one or more additives are not intentionally added to the polymer composition.

The polymer composition can exhibit one or more desirable properties. For example, the polymer composition can have a Tg of greater than 200° C., or 220 to 290° C., or 250 to 290° C.

The polymer composition can be prepared according to any method that is generally known. In some embodiments, the polymer composition is prepared by melt-mixing or a combination of dry-blending and melt-mixing. Melt-mixing can be performed in single or twin screw type extruders or similar mixing devices which can apply a shear and heat to the components. Melt-mixing can be performed at temperatures greater than or equal to the melting temperatures of the polymer components and less than the degradation temperatures of either of the polymer components. All of the ingredients can be added initially to the processing system. In some embodiments, the ingredients can be added sequentially or through the use of one or more master batches. It can be advantageous to apply a vacuum to the melt through one or more vent ports in the extruder to remove volatile impurities in the composition. In some embodiments the composition is the product of melt-mixing the polymers and, when present, any additives.

The polymer composition described herein can be used in the preparation of various articles. The composition of the present disclosure can be formed into articles using any suitable technique, for example, melt-processing techniques. Commonly used article-forming methods can include shaping, extruding, blow molding, injection molding, thermoforming, or laminating. In some embodiments, articles can be prepared by injection molding techniques. The compositions of the present disclosure can also be formed into sheets and both cast and blown films by extrusion. These films and sheets can be further thermoformed into articles and structures that can be oriented from the melt or at a later stage in the processing of the composition. The compositions can further be over-molded onto an article made from a different material or by a different process. The articles can also be formed using techniques such as compression molding or ram extruding. The articles can be further formed into other shapes by machining. Exemplary articles can include a molded part (e.g., an injection molded part), a film, a sheet, a multilayer sheet, a multilayer film, a multilayer laminate, an extruded shape, a coated part, a pellet, a powder, a foam, a fiber, a flaked fiber, an extruded sheet, an extruded film, an extruded fiber, tubing, or an extruded stock shape. In particular, the article can be an optical lens, an infrared lens, an optical fiber connector (e.g., with an integrated lens), an electrical connector, a light emitting diode (LED) reflector, a printed circuit board substrate (including rigid and flexible substrates), a reflector for a headlamp (e.g., an automotive headlamp), a reflector for an electronic device (e.g., a flashlight reflector on a handheld mobile device), an infrared-transparent covering or window (e.g., for a remote control or virtual reality device), a heat sink for an LED device, a magnetic tape substrate, a foamed panel (e.g., in an aircraft), or an automobile component.

The compositions, methods, and articles are further illustrated by the following examples, which are non-limiting.

### EXAMPLES

The materials used for the following examples are listed in Table 1.

TABLE 1

| Component | Description | Supplier |
|---|---|---|
| PEI-1 | Poly(biphenyl etherimide) made from the reaction of 3,3′-biphenol | |
| | dianhydride which is derived from 4,4′-biphenol, with meta-phenylene | |
| | diamine, having a glass transition temperature of 268° C. and a weight | |
| | average molecular weight of 31,000 g/mol based on polystyrene standards. | |
| PEI-2 | Polyetherimide made from the reaction of bisphenol A dianhydride with | SABIC |
| | meta-phenylene diamine, having a glass transition temperature of 217° C., | |
| | available as ULTEM 1010 | |
| PEI-3 | Polyetherimide made from the reaction of bisphenol A dianhydride with | SABIC |
| | para-phenylene diamine, having a glass transition temperature of 227° C., | |
| | available as ULTEM CRS5011 | |
| PEI-4 | Polyetherimide made from the reaction of bisphenol A dianhydride with | SABIC |
| | 4,4′-diaminodiphenylsulfone, having a glass transition temperature of | |
| | 247° C., available as EXTEM VH1003 | |
| PEI-Si | Polyetherimide made from the reaction of bisphenol A dianhydride, | SABIC |
| | G10 siloxane, and meta-phenylene diamine, available as SILTEM STM1500 | |
| PEEK-1 | Polyetheretherketone, commercially available as PEEK 150G | Victrex |
| PEEK-2 | Polyetheretherketone, commercially available as PEEK 450G | Victrex |
| PSU | Polysulfone derived from the polycondensation of a 4,4′- | Solvay |
| | dihalodiphenylsulfone and Bisphenol-A (CAS Reg. No. 25135-51-7), | |
| | commercially available as UDEL P-1700 | |
| PPSU | Polyphenyl sulfone derived from the polycondensation of 4,4′- | Solvay |
| | dihalodiphenyl sulfone and 4,4′-biphenol, commercially available as RADEL | |
| | R-5000 | |
| LCP | Liquid crystalline polymer, commercially available as ZENITE 5000 NC010 | Celanese |

### Polymer Composition Preparation

The polymer compositions of the following examples were prepared by dry-blending the desired quantities of the polymer components. The polymer compositions were prepared by extrusion of the dry pellet mixtures in a Haake Rheomic Lab Mixer (PolyLab). The mixer was set to a temperature of 355 to 385° C. The compositions were mixed at a speed of about 40 to 60 rpm under an inert atmosphere of nitrogen. The components were mixed in the molten state for 5 to 15 minutes. The resulting molten polymer composition was removed from the mixer, cooled, and converted into small pellets using a grinder. The resulting pellets were used for the testing described below.

### Physical Testing

Physical testing of the resulting compositions was carried out as described below.

Glass transition temperature (Tg) and melting temperature (Tm) were determined using Differential Scanning calorimetry (DSC) according to ASTM D3418. The test was performed using a TA Q1000 DSC instrument. In a typical procedure, a polymer sample (10-20 milligrams) was heated from 40 to 400° C. at a rate of 20° C./min, held at 400° C. for 1 minute, cooled to 40° C. at a rate of 20° C./min, then held at 40° C. for 1 minute, and the above heating/cooling cycle was repeated. The second heating cycle is usually used to obtain the Tg and Tm.

Thermal Gravimetric Analysis (TGA) measurements were performed with a TA Q800 TGA. The samples were scanned from 40 to 800° C. under nitrogen and air with a heating rate of 20° C./min. This analysis was used to determine the temperature of peak decomposition (also referred as the onset decomposition temperature), and char yield at the end of TGA run (at 800° C. under nitrogen). The weight loss (%) was also noted at 800° C.

The visual appearance of the compositions was assessed by evaluating the appearance of the composition to the unassisted eye on films of less than 1 mm thickness.

The polymer compositions and properties, including visual appearance and glass transition temperature, are shown in Tables 2A and 2B. The amount of each component is listed as weight percent, based on the total weight of the composition.

TABLE 2A

| | Component | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| PEI-1 | 100 | 25 | 50 | 75 | 25 | 50 | 75 | 25 | 50 | 75 | 25 | 50 | 75 | 25 |
| PEI-2 | | | | | | | | 75 | 50 | 25 | | | | |
| PEI-3 | | | | | | | | | | | 75 | 50 | 25 | |
| PEI-4 | | | | | | | | | | | | | | 75 |
| PEI-Si | | | | | | | | | | | | | | |
| PEEK-1 | | 75 | 50 | 25 | | | | | | | | | | |
| PEEK-2 | | | | | 75 | 50 | 25 | | | | | | | |
| PSU | | | | | | | | | | | | | | |
| PPSU | | | | | | | | | | | | | | |
| LCP | | | | | | | | | | | | | | |
| Properties | | | | | | | | | | | | | | |
| Visual | Clear | Clear | Clear | Opaque | Opaque | Clear | Opaque | Hazy | Hazy | Hazy | Clear | Hazy | Clear | Clear |
| Appearance | | | | | | | | | | | | | | |
| Tg (° C.) | 268 | 209 | 148 | 176 | 270 | 269 | 206 | 222 | 223 | 223 | 244 | 221 | 220 | 241 |
| | | | 270 | 269 | | | 269 | | 258 | 261 | | 262 | | |
| Tm (° C.) | — | 340 | 340 | 342 | 337 | 338 | 337 | | | | | | | |
| Tc (° C.) | — | 285 | 292 | 206 | 290 | 289 | 288 | | | | | | | |
| Onset | 550 | 575 | 560 | 556 | 570 | 559 | 546 | 539 | 530 | 531 | | | | |
| Decomp. | | | | | | | | | | | | | | |
| Temp. (° C.) | | | | | | | | | | | | | | |
| % Weight | 37 | 50 | 44 | 40 | 46 | 42 | 41 | 44 | 44 | 39 | | | | |
| Loss | | | | | | | | | | | | | | |

TABLE 2B

| | Component | | | | | | | | | | | | | |
|---|---|---|---|---|---|---|---|---|---|---|---|---|---|---|
| | 15 | 16 | 17 | 18 | 19 | 20 | 21 | 22 | 23 | 24 | 25 | 26 | 27 | 28 |
| PEI-1 | 50 | 75 | 25 | 50 | 75 | 25 | 50 | 75 | 25 | 50 | 75 | 25 | 50 | 75 |
| PEI-2 | | | | | | | | | | | | | | |
| PEI-3 | | | | | | | | | | | | | | |
| PEI-4 | 50 | 25 | | | | | | | | | | | | |
| PEI-Si | | | 75 | 50 | 25 | | | | | | | | | |
| PEEK-1 | | | | | | | | | | | | | | |
| PEEK-2 | | | | | | | | | | | | | | |
| PSU | | | | | | 75 | 50 | 25 | | | | | | |
| PPSU | | | | | | | | | 75 | 50 | 25 | | | |
| LCP | | | | | | | | | | | | 75 | 50 | 25 |
| Properties | | | | | | | | | | | | | | |
| Visual | Hazy | Clear | Clear | Hazy | Clear | Opaque | Opaque | Opaque | Clear | Clear | Clear | Opaque | Opaque | Opaque |
| Tg (° C.) | 235 | 244 | 262 | 266 | 254 | 263 | 264 | 263 | 264 | 261 | 263 | 258 | 260 | 256 |
| | 259 | | | | | 182 | 189 | 181 | 227 | 227 | 227 | | | |
| Tm (° C.) | | | | | | | | | | | | 321 | 323 | 314 |
| Tc (° C.) | | | | | | | | | | | | | | |
| Onset | | | 495 | 496 | | 570 | 564 | 560 | 539 | 540 | 536 | 521 | 520 | 512 |
| Decomp. | | | | | | | | | | | | | | |
| Temp. (° C.) | | | | | | | | | | | | | | |
| % Weight | | | 62 | 54 | | 58 | 49 | 42 | 47 | 41 | 37 | 55 | 49 | 43 |
| Loss | | | | | | | | | | | | | | |

As shown in Tables 2A and 2B, compositions were prepared including PEI-1 (i.e., a polyetherimide derived from a 3,3′-biphenol dianhydride and meta-phenylene diamine) and various PEEK polymers, other PEI polymers, a polysulfone, a polyphenylene sulfone, and a liquid crystal polymer. Depending on the particular amounts of the components used, the visual appearance of the compositions as well as the glass transition temperature could be tuned. Additionally, the compositions according to examples 9 and 12 exhibited two glass transition temperatures, characteristic of an immiscible polymer blend.

This disclosure further encompasses the following embodiments, which are non-limiting.

### Embodiment 1

A polymer composition comprising a poly(biphenyl etherimide) having a Tg of greater than 230° C., or 240 to 310° C., or 250 to 290° C., and comprising repeating units of formula (1)

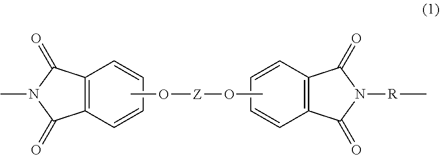

wherein Z is independently at each occurrence derived from a 4,4′-biphenol; and the divalent bonds of the —O—Z—O— group are in the 3,3′, 3,4′, 4,3′, or the 4,4′ positions, preferably the 3,3′ position; and R is independently at each occurrence a C₆₋₂₀ aromatic hydrocarbon group or a halogenated derivative thereof, a straight or branched chain C₂₋₂₀ alkylene group or a halogenated derivative thereof, or a C₃₋₈ cycloalkylene group or a halogenated derivative thereof; and a second polymer that is not the same as the poly(biphenyl etherimide), preferably wherein the second polymer has a Tg of greater than 160° C., or 200 to 300° C., or 220 to 290° C.; or a Tm of greater than 260° C., or 260 to 350° C., or 300 to 350° C.

### Embodiment 2

The polymer composition of embodiment 1, comprising 1 to 99 wt %, preferably from 10 to 90 wt %, more preferably from 25 to 75 wt % of the poly(biphenyl etherimide); and 1 to 99 wt %, preferably from 10 to 90 wt %, more preferably from 25 to 75 wt % of the second polymer, wherein the weight percent is based on the total weight of the poly(biphenyl etherimide) and the second polymer, and totals 100%.

### Embodiment 3

The polymer composition of embodiment 1 or 2, wherein the polymer composition has at least one of a Tg of greater than 200° C., or 220 to 290° C., or 250 to 290° C.; or a char yield of greater than 30 weight percent, as determined using thermogravimetric analysis under inert atmosphere of nitrogen.

### Embodiment 4

The polymer composition of any of one or more the preceding embodiments, wherein Z is a group derived from 4,4′-biphenol, and R is an m-phenylene group, p-phenylene group, diarylene sulfone group, diarylene ether group, or a combination comprising at least one of the foregoing.

### Embodiment 5

The polymer composition of any of one or more the preceding embodiments, wherein R is a meta-phenylene group.

### Embodiment 6

The polymer composition of any of one or more the preceding embodiments, wherein the poly(biphenyl etherimide) has at least one of: a weight average molecular weight of at least 10,000 grams per mole, preferably 20,000 to 100,000 grams per mole, more preferably 20,000 to 60,000 grams per mole; comprises less than 2 wt % of cyclic oligomers, preferably less than 1.25 wt %; more preferably less than 0.5 wt % of cyclic oligomers; and an onset decomposition temperature of greater than 400° C. as determined using thermogravimetric analysis in nitrogen.

### Embodiment 7

The polymer composition of any of one or more the preceding embodiments, wherein the poly(biphenyl etherimide) is formed by reacting a bis(phthalimide) of the formula

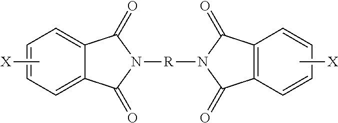

and an alkali metal salt of the formula

M⁺⁻O—Z—O⁻⁺M

under conditions effective to form the poly(biphenyl etherimide), wherein each X is independently a halogen or a nitro group; M is an alkali metal; and R and Z are as defined in embodiment 1.

### Embodiment 8

The polymer composition of embodiment 7, wherein the reacting is in the presence of an end-capping agent, preferably wherein the end-capping agent comprises a monophenol or the corresponding alkali metal salt thereof, preferably sodium phenoxide, more preferably sodium para-cumyl phenol; or in the presence of a catalyst, preferably wherein the catalyst is a quaternary ammonium salt, guanidinium salt, pyridinium salt, imidazolium salt, or a combination comprising at least one of the foregoing, more preferably wherein the catalyst is a hexaalkylguanidinium salt, even more preferably wherein the catalyst is hexaethylguanidinium chloride; or the alkali metal salt of the dihydroxy compound is present in 1.6 to 2.0 molar excess relative to the bis(halophthalimide) composition.

### Embodiment 9

The polymer composition of any of one or more of embodiments 1 to 6, wherein the poly(biphenyl etherimide) is formed by reacting an aromatic bis(ether phthalic anhydride) of formula (8)

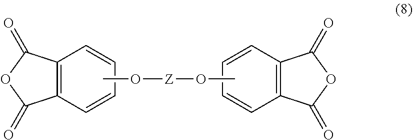

with an aromatic diamine of the formula

H₂N—R—NH₂

to provide the first poly(etherimide), wherein in the foregoing formulas R and Z are as defined in embodiment 1.

### Embodiment 10

The polymer composition of embodiment 9, wherein the poly(biphenyl etherimide) is end-capped with a substituted or unsubstituted aromatic primary monoamine or a substituted or unsubstituted phthalic anhydride.

### Embodiment 11

The polymer composition of any one or more of the preceding embodiments, wherein the second polymer is a polyarylene ether, a polyarylene sulfide, a polyarylether ketone, a polyarylether sulfone, a polyarylsulfone, a polybenzimidazole, a polyimide, a polyamide imide, a liquid crystalline polymer, or a combination comprising at least one of the foregoing, preferably wherein the second polymer is a polyarylether ketone, a polyetherimide, a polyarylether sulfone, a polyarylsulfone, a liquid crystal polymer, or a combination comprising at least one of the foregoing.

### Embodiment 12

The polymer composition of any one or more of embodiments 1-11, wherein the composition is a miscible composition comprising 10 to less than 40 wt %, preferably 20 to 30 wt % of the poly(biphenyl etherimide); and greater than 60 to 90 wt %, preferably 70 to 80 wt % of the second polymer, preferably wherein the second polymer is a polyimide different from the poly(biphenyl etherimide), wherein the wt % is based on the total weight of the poly(biphenyl etherimide) and the second polymer and totals 100%; and wherein the miscible composition exhibits at least one of one glass transition temperature, preferably wherein the glass transition temperature is 150 to 300° C.; and no melting point.

### Embodiment 13

The polymer composition of any one or more of embodiments 1-12, wherein the composition is a miscible composition comprising greater than 60 to 90 wt %, preferably 70 to 80 wt % of the poly(biphenyl etherimide); and 10 to less than 40 wt %, preferably 20 to 30 wt % of the second polymer, preferably wherein the second polymer is a polyimide different from the poly(biphenyl etherimide), wherein the wt % is based on the total weight of the poly(biphenyl etherimide) and the second polymer and totals 100%; and wherein the miscible composition exhibits at least one of one glass transition temperature, preferably wherein the glass transition temperature is 150 to 300° C.; and no melting point.

### Embodiment 14

The polymer composition of any one or more of embodiments 1-12, wherein the composition is an immiscible composition comprising 40 to 60 wt %, preferably 45 to 55 wt % of the poly(biphenyl etherimide); and 40 to 60 wt %, preferably 45 to 55 wt % of the second polymer, preferably wherein the second polymer is a polyimide different from the poly(biphenyl etherimide), wherein the weight percent is based on the total weight of the poly(biphenyl etherimide) and the second polymer, and totals 100%; and wherein the immiscible composition exhibits at least one of more than one glass transition temperature between 150 and 300° C.; and a melting point.

### Embodiment 15

The polymer composition of any one or more of the preceding embodiments, further comprising a filler, reinforcing agent, lubricant, colorant, stabilizer, mold release agent, UV absorber, or a combination comprising at least one of the foregoing.

### Embodiment 16

A method of making the polymer composition of any one or more of the preceding embodiments, comprising melt-mixing the poly(biphenyl etherimide) and the second polymer.

### Embodiment 17

An article comprising the polymer composition of any one or more of embodiments 1 to 15, or the polymer composition made by the method of embodiment 16.

### Embodiment 18

The article of embodiment 17, wherein the article is a molded part, a film, a sheet, a multilayer sheet, a multilayer film, a multilayer laminate, an extruded shape, a coated part, a pellet, a powder, a foam, a fiber, a flaked fiber, an extruded sheet, an extruded film, an extruded fiber, tubing, or an extruded stock shape, preferably wherein the article is an optical lens, an infrared lens, optical fiber connector, an electrical connector, an LED reflector, a printed circuit board substrate, a reflector for automotive headlamp, a reflector for an electronic device, or an infrared-transparent covering or window.

### Embodiment 19

A method of forming the article of any one or more of embodiments 17 to 18, comprising shaping, extruding, blow molding, injection molding, thermoforming, or laminating the polymer composition of any one or more of embodiments 1 to 15, or the polymer composition made by the method of embodiment 16.

In general, the compositions, methods, and articles can alternatively comprise, consist of, or consist essentially of, any appropriate components herein disclosed. The compositions, methods and articles can additionally, or alternatively, be formulated so as to be devoid, or substantially free, of any components, materials, ingredients, adjuvants, steps, or species used in the prior art compositions or methods that are otherwise not necessary to the achievement of the function and/or objectives of the present invention.

All ranges disclosed herein are inclusive of the endpoints, and the endpoints are independently combinable with each other. “Combination” is inclusive of blends, mixtures, alloys, reaction products, and the like. “Or” means “and/or.” Furthermore, the terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. In addition, it is to be understood that the described elements can be combined in any suitable manner in the various embodiments.

As used herein, the term “hydrocarbyl” includes groups containing carbon, hydrogen, and optionally one or more heteroatoms (e.g., 1, 2, 3, or 4 atoms such as halogen, 0, N, S, P, or Si). “Alkyl” means a branched or straight chain, saturated, monovalent hydrocarbon group, e.g., methyl, ethyl, i-propyl, and n-butyl. “Alkylene” means a straight or branched chain, saturated, divalent hydrocarbon group (e.g., methylene (—CH₂—) or propylene (—(CH₂)₃—)). “Alkenyl” and “alkenylene” mean a monovalent or divalent, respectively, straight or branched chain hydrocarbon group having at least one carbon-carbon double bond (e.g., ethenyl (—HC═CH₂) or propenylene (—HC(CH₃)═CH₂—). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy, ethoxy, and sec-butyloxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclizations. “Aryl” means a monovalent, monocyclic or polycyclic aromatic group (e.g., phenyl or naphthyl). “Arylene” means a divalent, monocyclic or polycyclic aromatic group (e.g., phenylene or naphthylene). The prefix “halo” means a group or compound including one more halogen (F, Cl, Br, or I) substituents, which can be the same or different. The prefix “hetero” means a group or compound that includes at least one ring member that is a heteroatom (e.g., 1, 2, or 3 heteroatoms, wherein each heteroatom is independently N, O, S, or P.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g, benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the group, including those of the substituent(s).

All cited patents, patent applications, and other references are incorporated herein by reference in their entirety. While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polymer composition comprising
a poly(biphenyl etherimide) having a Tg of greater than 230° C., and comprising repeating units of formula (1) 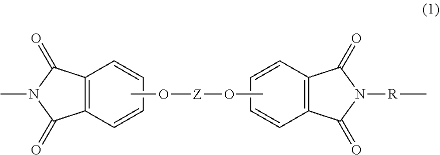
wherein
Z is independently at each occurrence derived from a 4,4′-biphenol; and
the divalent bonds of the —O—Z—O— group are in the 3,3′, 3,4′, 4,3′, or the 4,4′ positions; and
R is independently at each occurrence a C₆₋₂₀ aromatic hydrocarbon group or a halogenated derivative thereof, a straight or branched chain C₂₋₂₀ alkylene group or a halogenated derivative thereof, or a C₃₋₈ cycloalkylene group or a halogenated derivative thereof; and
a second polymer that is not the same as the poly(biphenyl etherimide).

2. The polymer composition of claim 1, comprising
1 to 99 weight percent of the poly(biphenyl etherimide); and
1 to 99 weight percent of the second polymer,
wherein the weight percent is based on the total weight of the poly(biphenyl etherimide) and the second polymer, and totals 100%.

3. The polymer composition of claim 1, wherein the polymer composition has at least one of
a Tg of greater than 200° C.; or
a char yield of greater than 30 weight percent, as determined using thermogravimetric analysis under inert atmosphere of nitrogen.

4. The polymer composition of claim 1, wherein
Z is a group derived from 4,4′-biphenol, and
R is an m-phenylene group, p-phenylene group, diarylene sulfone group, diarylene ether group, or a combination comprising at least one of the foregoing.

5. The polymer composition of claim 1, wherein R is a meta-phenylene group.

6. The polymer composition of claim 1, wherein the poly(biphenyl etherimide) has at least one of:
a weight average molecular weight of at least 10,000 grams per mole;
comprises less than 2 weight percent of cyclic oligomers; and
has an onset decomposition temperature of greater than 400° C. as determined using thermogravimetric analysis in nitrogen.

7. The polymer composition of claim 1, wherein the poly(biphenyl etherimide) is formed by reacting a bis(phthalimide) of the formula 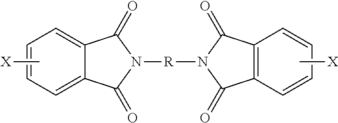
and an alkali metal salt of the formula
M⁺⁻O—Z—O⁻⁺M
under conditions effective to form the poly(biphenyl etherimide),
wherein
each X is independently a halogen or a nitro group;
M is an alkali metal; and
R and Z are as defined in claim 1.

8. The polymer composition of claim 7, wherein the reacting is
in the presence of an end-capping agent; or
in the presence of a catalyst; or
the alkali metal salt of the dihydroxy compound is present in 1.6 to 2.0 molar excess relative to the bis(halophthalimide) composition.

9. The polymer composition of claim 1, wherein the poly(biphenyl etherimide) is formed by reacting an aromatic bis(ether phthalic anhydride) of formula (8) 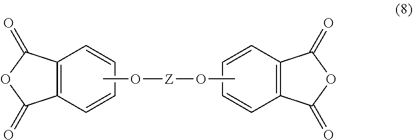
with an aromatic diamine of the formula
H₂N—R—NH₂
to provide the first poly(etherimide), wherein in the foregoing formulas
R and Z are as defined in claim 1.

10. The polymer composition of claim 9, wherein the poly(biphenyl etherimide) is end-capped with a substituted or unsubstituted aromatic primary monoamine or a substituted or unsubstituted phthalic anhydride.

11. The polymer composition of claim 1, wherein the second polymer is a polyarylene ether, a polyarylene sulfide, a polyarylether ketone, a polyarylether sulfone, a polyaryl sulfone, a polybenzimidazole, a polyimide, a polyamide imide, a liquid crystalline polymer, or a combination comprising at least one of the foregoing.

12. The polymer composition of claim 1, wherein the composition is a miscible composition comprising
10 to less than 40 weight percent of the poly(biphenyl etherimide); and
greater than 60 to 90 weight percent of the second polymer,
wherein the weight percent is based on the total weight of the poly(biphenyl etherimide) and the second polymer and totals 100%; and
wherein the miscible composition exhibits at least one of
one glass transition temperature, preferably wherein the glass transition temperature is 150 to 300° C.; and
no melting point.

13. The polymer composition of claim 1, wherein the composition is a miscible composition comprising
greater than 60 to 90 weight percent of the poly(biphenyl etherimide); and
10 to less than 40 weight percent of the second polymer,
wherein the weight percent is based on the total weight of the poly(biphenyl etherimide) and the second polymer and totals 100%; and
wherein the miscible composition exhibits at least one of
one glass transition temperature, preferably wherein the glass transition temperature is 150 to 300° C.; and
no melting point.

14. The polymer composition of claim 1, wherein the composition is an immiscible composition comprising
40 to 60 weight percent of the poly(biphenyl etherimide); and
40 to 60 weight percent of the second polymer,
wherein the weight percent is based on the total weight of the poly(biphenyl etherimide) and the second polymer, and totals 100%; and
wherein the immiscible composition exhibits at least one of
more than one glass transition temperature between 150 and 300° C.; and
a melting point.

15. The polymer composition of claim 1, further comprising a filler, reinforcing agent, lubricant, colorant, stabilizer, mold release agent, UV absorber, or a combination comprising at least one of the foregoing.

16. A method of making the polymer composition of claim 1, comprising melt-mixing the poly(biphenyl etherimide) and the second polymer.

17. An article comprising the polymer composition of claim 1.

18. The article of claim 17, wherein
the article is a molded part, a film, a sheet, a multilayer sheet, a multilayer film, a multilayer laminate, an extruded shape, a coated part, a pellet, a powder, a foam, a fiber, a flaked fiber, an extruded sheet, an extruded film, an extruded fiber, tubing, or an extruded stock shape.

19. A method of forming the article of claim 17, comprising shaping, extruding, blow molding, injection molding, thermoforming, or laminating the polymer composition of claim 1.
